(19) United States
(12) Patent Application Publication
(10) Pub. No.: US 2016/0050083 A1
(43) Pub. Date: Feb. 18, 2016

(54) INFORMATION PROCESSING METHOD AND ELECTRONIC DEVICE

(71) Applicants: BEIJING LENOVO SOFTWARE LTD., BEIJING (CN); LENOVO (BEIJING) LIMITED, BEIJING (CN)

(72) Inventors: KAI KANG, BEIJING (CN); LIUXIN ZHANG, BEIJING (CN); XIANG CAO, BEIJING (CN); JINFENG ZHANG, BEIJING (CN)

(21) Appl. No.: 14/645,160

(22) Filed: Mar. 11, 2015

(30) Foreign Application Priority Data
Aug. 14, 2014 (CN) 201410400177.0
Sep. 9, 2014 (CN) 201410455786.6

(51) Int. Cl. H04L 12/28; H04M 1/725

(52) U.S. Cl. CPC H04L 12/2825; H04M 1/72533; H04L 12/2818; H04L 2012/2841

(57) ABSTRACT

The present disclosure provides an information processing method. The method comprises: establishing a connection channel among a plurality of electronic devices; acquiring a plurality of record items through the connection channel, each record item being generated in response to an operation on a respective electronic device; generating a record list which comprises the plurality of the record items; and processing the record list to associate at least two record items from the plurality of record items, in order to cause respective operations of the electronic devices, to which said at least two record items correspond, to be performed. In addition, the present disclosure further provides a corresponding electronic device.

### CROSS-REFERENCE TO RELATED APPLICATION(S)

This application claims priority to the Chinese Patent Application No. 201410400177.0, filed on Aug. 14, 2014, entitled “INFORMATION PROCESSING METHOD AND ELECTRONIC DEVICE” and the Chinese Patent Application No. 201410455786.6, filed on Sep. 9, 2014, entitled “INFORMATION PROCESSING METHOD AND ELECTRONIC DEVICE” which are incorporated herein by reference in their entireties.

### TECHNICAL FIELD

The present disclosure relates to the field of electronic technologies, and in particular, to an information processing method and an electronic device.

### BACKGROUND

Nowadays, various intelligent household devices such as intelligent illuminating systems, electrically-driven curtains, intelligent air conditioners or the like bring great convenience to people's lives. Users may control the intelligent household devices according to their own wills. For example, an intelligent air conditioner is controlled to automatically turn on in a refrigeration mode at 6 p.m., and an electrically-driven curtain is controlled to be automatically drawn close when an ambient light is very bright.

However, the existing intelligent household devices are isolated devices, which can only be set manually by users. For example, when a user wants to control three intelligent household devices, he/she has to perform three settings for the three intelligent household devices, respectively.

In addition, in the related art, a user may set an intelligent household device using software installed on a mobile device (such as a mobile phone). Therefore, software for many intelligent household devices tends to be installed on the user's mobile phone. As the software cannot be controlled in a unified manner, various intelligent household devices can only be controlled individually by the user using corresponding softwares.

Thus, as various intelligent household devices can only be controlled individually by the user in a manual manner, the method for controlling an intelligent household device is too simple and not intelligent enough.

### SUMMARY

In an aspect, some embodiments of the present disclosure provide an information processing method. The method comprises: establishing a connection channel among a plurality of electronic devices; acquiring a plurality of record items through the connection channel, each record item being generated in response to an operation on a respective electronic device; generating a record list which comprises the plurality of the record items; and processing the record list to associate at least two record items from the plurality of record items, in order to cause respective operations of the electronic devices, to which said at least two record items correspond, to be performed.

In a second aspect, some other embodiments of the present disclosure provide an electronic device. The electronic device comprises: a communication unit configured to establish a connection channel with a plurality of electronic devices; a processor configured to acquire a plurality of record items through the connection channel, each record item being generated in response to an operation on a respective electronic device through the connection channel; to generate a record list which comprises the plurality of the record items; and to process the record list to associate at least two record items from the plurality of record items, in order to cause respective operations of the electronic devices, to which said at least two record items correspond, to be performed.

### BRIEF DESCRIPTION OF THE DRAWINGS

FIG. 1 is a flowchart of an information processing method according to a first embodiment of the present disclosure.

FIG. 2 is a diagram of record items of various intelligent household devices according to the first embodiment of the present disclosure.

FIG. 3 is a diagram of generation of an association rule according to the first embodiment of the present disclosure.

FIG. 4 is a diagram of generation of recommendation information according to the first embodiment of the present disclosure.

FIG. 5 is a diagram of record items of various intelligent household devices comprising a user's operation actions according to a second embodiment of the present disclosure.

FIG. 6 is a diagram of record items of various intelligent household devices comprising user information according to a fourth embodiment of the present disclosure.

FIG. 7 is a block diagram of a structure of an electronic device according to a fifth embodiment of the present disclosure.

FIG. 8 is a flowchart of an information processing method according to a sixth embodiment of the present disclosure.

FIG. 9 is a diagram of a correlation template according to the sixth embodiment of the present disclosure.

FIG. 10 is a diagram of add of a “Then” result according to the sixth embodiment of the present disclosure.

FIG. 11 is a diagram of “end the presentation” according to the sixth embodiment of the present disclosure.

FIG. 12 is a diagram of successful add of an association rule according to the sixth embodiment of the present disclosure.

FIG. 13 is a block diagram of a structure of an electronic device according to a seventh embodiment of the present disclosure.

### DETAILED DESCRIPTION

In the technical solutions according to some embodiments of the present disclosure, a record item of each intelligent household device is detected and generated, wherein the record item comprises a response result of said each intelligent household device, a record list is generated according to record items of various intelligent household devices, and corresponding association information is generated according to a predetermined rule, so that multiple intelligent household devices in a one-to-one correspondence with multiple record items make associative responses. With the solution according to the embodiments of the present disclosure, multiple intelligent household devices associated with an intelligent household device can make a correlation response after a response is made to a user's operation action on the intelligent household device without a user setting various intelligent household devices individually, thereby eliminating the technical problem in the related art that the method for controlling an intelligent household device is too simple and not intelligent and providing a novel and more intelligent control manner.

The main implementation principles, detailed description, and corresponding beneficial effects to be achieved of the technical solutions according to the embodiments of the present disclosure will be described in detail below in combination with accompanying drawings.

The embodiments of the present disclosure provide an electronic device, which may be a cloud server connected to multiple independent intelligent household devices in a physical space; or a central control device positioned in a physical space and connected to multiple independent intelligent household devices in the physical space. The central control device may be an intelligent router or an intelligent HUB. Of course, the electronic device may also be an intelligent management device in a physical space having a display screen and a sensor unit, and a user may interact with the intelligent management device through the sensor unit to control the multiple independent intelligent household devices in the physical space. On the whole, the electronic device according to the embodiments of the present disclosure can be connected to multiple independent intelligent household devices in the physical space; and can monitor and control each independent intelligent electronic device connected thereto.

Each of the multiple independent intelligent household devices according to the embodiments of the present disclosure is an independent intelligent electronic device. Said each independent intelligent household device can independently acquire a user's operation on the intelligent household device itself, and when said each intelligent household device is connected to the electronic device according to the embodiments of the present disclosure, the intelligent household device can receive a control instruction transmitted by the electronic device and automatically make a response to the control instruction. For example, the independent electronic intelligent household device may be an intelligent light. In this case, a user may operate a switch of the intelligent light, and in response to the user's operation on the switch, the intelligent light is controlled to turn on or turn off; or the user may operate a brightness adjustment key of the intelligent light (a virtual key or a hardware key), and in response to the user's operation on the brightness adjustment key, the intelligent light is controlled to adjust the glowing effect of the intelligent light so as to achieve adjustment of the intensity; and at the same time, the intelligent light may acquire a control instruction transmitted by the electronic device according to the present disclosure and can automatically make a response to the control instruction. For example, a turn-on instruction/turn-off instruction is received from the electronic device according to the present disclosure, and in response to the turn-on instruction, the intelligent light is automatically controlled to turn on/in response to the turn-off instruction, the intelligent light is automatically controlled to turn off; and further, multiple control instructions are simultaneously transmitted from the electronic device according to the present disclosure to each of multiple independent intelligent household devices. In addition, each of the multiple independent intelligent household devices can receive the multiple instructions and can make a response to the multiple control instructions directed to the device itself. For example, when the intelligent light receives a turn-on instruction and a brightness adjustment instruction for adjusting to 50% of the brightness, the intelligent light is automatically controlled to turn on in response to the turn-on instruction and automatically makes a response to the brightness adjustment instruction for adjusting to 50% of the brightness. The intelligent household device according to the embodiments of the present disclosure which can be positioned in a physical space may be another device, for example, an audio and video device such as an intelligent television, an intelligent player or the like, which can be controlled by the electronic device according to the embodiments of the present disclosure to turn on/turn off, to switch to a specified channel, or to adjust a parameter for an output effect (such as volume, display brightness, display color or the like); for example, an illuminating system such as an intelligent light (as above); for example, a curtain/window system, which can be controlled by the electronic device according to the embodiments of the present disclosure to turn on/turn off; for example, an indoor air conditioning system, which can be controlled by the electronic device according to the embodiments of the present disclosure to turn on/turn off, or to adjust the freshness of the indoor air; for example, a temperature control system such as an intelligent air conditioner, an intelligent heater or the like, which can be controlled by the electronic device according to the embodiments of the present disclosure to turn on/turn off, or adjust the indoor temperature; for example, a security and protection system such as an intelligent cat eye or an intelligent monitor, which can be controlled by the electronic device according to the embodiments of the present disclosure to turn on/turn off, or to adjust an angle of the monitor or the definition of the monitor, and/or to store an image or a video; for example, an intelligent server such as an intelligent storage, which can be controlled by the electronic device according to the embodiments of the present disclosure to turn on/turn off, or to automatically store data downloaded from a network terminal; for example, an intelligent water heater, which can be controlled by the electronic device according to the embodiments of the present disclosure to turn on/turn off, or to generate hot water at a certain temperature and of a certain capacity; for example, an intelligent water tap, which can be controlled by the electronic device according to the embodiments of the present disclosure to turn on/turn off, or to discharge hot water at a certain temperature and/or cold water at a certain temperature; and for example, an intelligent door lock, which can be controlled by the electronic device according to the embodiments of the present disclosure to turn on/turn off or the like.

### First Embodiment

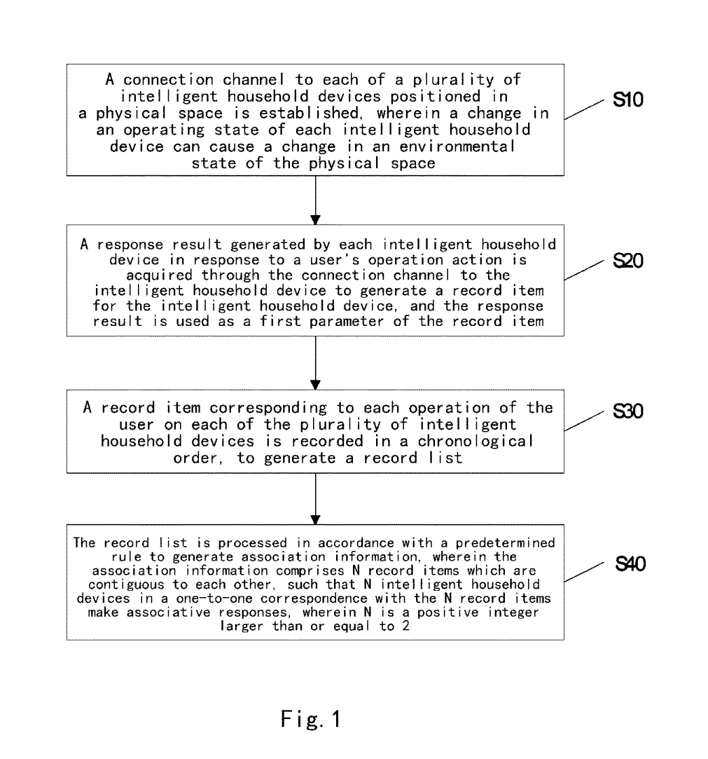

The first embodiment of the present disclosure provides an information processing method applied in an electronic device. As shown in FIG. 1, the method comprises the following steps.

In step S10, a connection channel to each of multiple intelligent household devices positioned in a physical space is established, wherein a change in an operating state of said each intelligent household device can cause a change in an environmental state of the physical space.

Specifically, an intelligent household device may be directly connected to a cloud server through WiFi, or may also be connected to an HUB and/or a router, which is not limited in the present disclosure.

Then, a step S20 is performed. In step S20, a record item of said each intelligent household device is generated by acquiring a response result generated by said each intelligent household device in response to a user's operation action through a connection channel to said each intelligent household device, and the response result is used as a first parameter of the record item.

Specifically, the record item comprises a response result of each intelligent household device in response to a user's operation action, and the response result is a change in an operating state of each intelligent household device. For example, with respect to the user's operation action of turning on the light, the response result is the light being turned on, and with respect to the user's operation action of opening the door, the response result is the door lock being unlocked.

In a specific implementation, after generating a response result in response to the user's operation action, each intelligent household device reports the response result to the electronic device according to the present disclosure (such as a cloud server, or a central control device, or an intelligent management device having a display screen and a sensor unit) through the connection channel. Of course, the electronic device according to the present disclosure may also monitor any of the multiple independent intelligent household devices through connection channels established respectively to the multiple independent intelligent household devices. When each intelligent household device generates a response result in response to the user's operation action, the response result can be acquired by the electronic device according to the present disclosure.

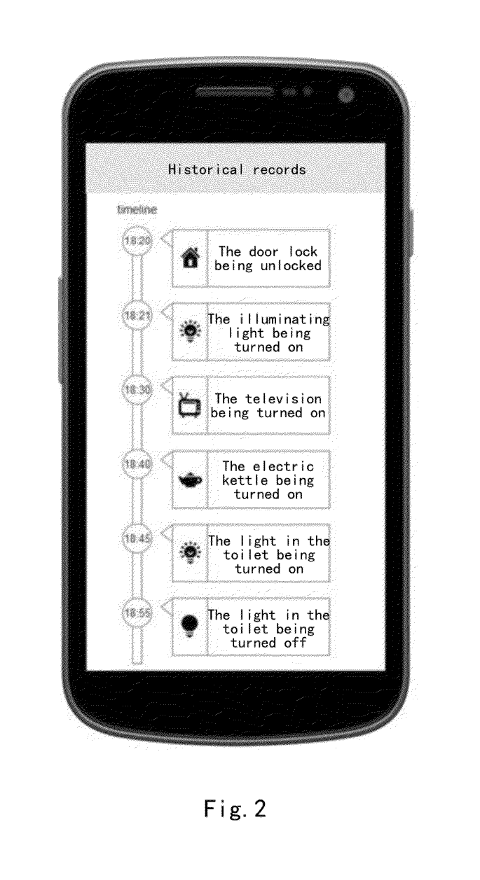

As shown in FIG. 2, the acquired record item of each intelligent household device may be the door lock being unlocked, the illuminating light being turned on, the television being turned on or the like.

Then, each intelligent household device transmits the response result to the electronic device connected thereto through a respective connection channel to the electronic device. For example, if each intelligent household device is connected to a cloud server through WiFi, said each intelligent household device transmits the response result to the cloud server for storage.

Then, step S30 is performed. In step S30, a record list is generated by recording a record item corresponding to each operation of the user on each of the multiple intelligent household devices in a chronological order.

Specifically, a response result corresponding to each operation of the user on each of the multiple intelligent household devices is recorded in a chronological order, and as long as a response result is generated by an intelligent household device, a corresponding record item is recorded by the electronic device.

As shown in FIG. 2, a record list is comprised of 6 record items, which are the door lock being unlocked at 18:20, the illuminating light being turned on at 18:21, the television being turned on at 18:30, the electric kettle being turned on at 18:40, the light in the toilet being turned on at 18:45, and the light in the toilet being turned off at 18:55.

In a specific implementation, each record list may comprise more record items, such as 100 or 200 record items. Alternatively, the record lists may further be divided in units of time length, for example, a weekly record list, an everyday record list or the like. In each record list, there may be multiple record items within the same time of period, for example, both the television being turned on and the electric kettle being turned on at 18:30, which is not limited in the present disclosure.

Then, step S40 is performed. In step S40, association information is generated by processing the record list in accordance with a predetermined rule, wherein the association information comprises N record items which are contiguous, so that N intelligent household devices in a one-to-one correspondence with the N record items make associative responses, wherein N is a positive integer larger than or equal to 2.

In the embodiment of the present disclosure, the predetermined rule may be defined as an interval among the N record items in the record list being less than an interval threshold.

Specifically, an interval between every two contiguous record items of N contiguous record items is less than the interval threshold.

For example, there are three record items, which are the door lock being unlocked at 18:20, the illuminating light being turned on at 18:21 and the television being turned on at 18:30 respectively. An interval between the first record item and the second record item is 1 minute, and an interval between the second record item and the third record item is 9 minutes. When it is assumed that the interval threshold is 10 minutes, the above three record items meet the predetermined rule; and when it is assumed that the interval threshold is 5 minutes, the above third record item does not meet the predetermined rule, while the first two record items, i.e., the door lock being unlocked at 18:20 and the illuminating light being turned on at 18:21, meet the predetermined rule.

In the embodiment of the present disclosure, the predetermined rule may also be defined as a number of occurrences of the N record items in the record list being greater than a number threshold.

Specifically, a number of occurrences of the N record items in the record list is greater than a number threshold. Whenever the N record items occur, they occur in the same order.

For example, there are three record items in an order of the door lock being unlocked, the illuminating light being turned on and the television being turned on, and these record items occur four times in the record list on July 25. When the number threshold is 3, the above three record items meet the predetermined rule, and when the number threshold is 5, the above three record items do not meet the predetermined rule.

In the embodiment of the present disclosure, the predefined rule may also be defined as an interval between every two contiguous record items being less than an interval threshold and a number of occurrences of the N record items in the record list being greater than a number threshold. The details will not be described here in the present disclosure.

In the embodiment of the present disclosure, the association information comprises N record items, wherein N is an integer larger than or equal to 2. The N record items are contiguous in the record list. After the above association information comprising N record items is generated, N intelligent household devices in a one-to-one correspondence with the N record items can make associative responses. In the embodiment of the present disclosure, two manners for generating association information according to record items are described as follows. In practical applications, it is not limited to the following two manners.

In a first manner, the generated association information is an association rule.

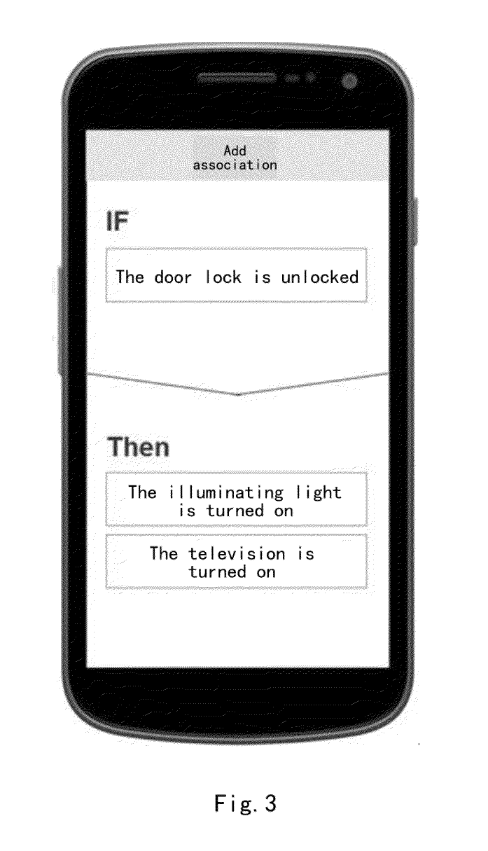

Specifically, it is assumed that N record items in the record list which meet the predetermined rule are three record items as follows: the door lock being unlocked, the illuminating light being turned on and the television being turned on. Then, the generated association rule is that if the door lock is unlocked, the illuminating light is turned on and the television is in turned on, as shown in FIG. 3. Alternatively, the generated association rule may also be that if the door lock is unlocked and the illuminating light is turned on, the television is in turned on. Then, the generated association rule is stored in the electronic device according to the embodiment of the present disclosure.

In the embodiment of the present disclosure, after the generating of the association rule, the method further comprises the following steps.

In a first step, parameter information in the process of generating a response result by a first intelligent household device of the N intelligent household devices in response to a user's operation action is acquired through a first connection channel established between the first intelligent household device and the electronic device.

In a second step, it is judged whether the parameter information matches with the association rule.

In a third step, when the parameter information matches with the association rule, a control instruction is transmitted to a second intelligent household device of the N intelligent household devices through a second connection channel established between the second intelligent household device and the electronic device, so that the second intelligent household device generates a second response result in response to the control instruction, wherein the second response result generated by the second intelligent household device in response to the control instruction is equivalent to a response result generated by the second intelligent household device in response to a user's operation action.

Specifically, in the first step, the acquired parameter information in the process of generating a response result in response to the user's operation action is reported by the first intelligent household device to the electronic device according to the embodiment of the present disclosure through the established connection channel to the electronic device.

Specifically, there are four cases for the composition of the parameter information.

In a first case, the parameter information comprises a response result generated in response to the user's operation action, such as the door lock being unlocked, the television being turned on or the like.

In a second case, the parameter information comprises the user's operation action, such as the user inserting a key and/or twisting the key, the user touching a switch of an intelligent light, or the user touching a sensing area of an intelligent door lock.

In a third case, the parameter information comprises user information for a user, for example, the user being SanZhang (acquired by means of fingerprints, face recognition, iris or the like, which is not limited in the embodiment of the present disclosure).

In a fourth case, the parameter information comprises the user information for a user, the user's operation action, and the user result generated in response to the operation action, for example, a user named SanZhang unlocking the door lock by pressing a fingerprint.

Further, assuming that the parameter information reported by the first intelligent household device to the electronic device is the response result, in the second step and the third step, the electronic device associates the acquired response result with multiple association rules stored in the electronic device. When the matching is successful, control instructions for controlling other intelligent household devices associated with the first intelligent household device are generated and the control instructions are transmitted respectively to said other intelligent household devices associated with the first intelligent household device.

Specifically, assuming that the association rule stored in the electronic device is that if the door lock is unlocked, the illuminating light is turned on and the television is in turned on, assume that the user unlocks the door lock, after receiving a response result of the door lock being unlocked which is reported by the intelligent door lock, the electronic device according to the embodiment of the present disclosure matches with the response result with the stored association rule, and when the matching is successful, the electronic device transmits a control instruction to the illuminating light to control the illuminating light to turn on and transmits another control instruction to the television to control the television to turn on.

Further, in the embodiment of the present disclosure, the method further comprises: after the judging of whether the parameter information matches with the association rule, when the parameter information matches with the association rule, changing to a correlation record item a record item representing existence of the process of generating a response result by the first intelligent household device in response to the user's operation action.

Specifically, after detecting the response result, the user′ operation action and the user information, the intelligent household device reports the above parameter information to the electronic device connected thereto, and when the parameter information matches with the association rule, the electronic device changes a record item comprising the above parameters to a correlation record item, and stores the correlation record item.

Alternatively, when the parameter information does not match with the association rule, a new record item representing existence of the process of generating a response result by the first intelligent household device in response to the user's operation action is generated.

Specifically, in the process of generating a response result by the first intelligent household device, after detecting the response result, the user's operation action and the user information, the intelligent household device reports the above parameter information to the electronic device connected thereto, and when the parameter information does not match the association rule, the electronic device stores one or more of the above received parameter information in a new record item.

Specifically, the new record item may only comprise the response result, or may also comprise the response result and the operation action, or may also comprise the response result and the user information, or may also comprise the response result, the operation action, and the user information. The specific content comprised in the new record item may be set by those skilled in the art according to practical requirements, which is not limited in the present disclosure. In a first manner according to the embodiment of the present disclosure, the electronic device automatically simulates the response result of the user's operation action, so that the user can control operating states of the illuminating light and the television without operating the illuminating light and the intelligent television respectively.

In the embodiment of the present application, as association rules of other users are comprised in the intelligent household system, before generating the association rule, the electronic device may automatically acquire the association rules of other users in the network, and then optimize the association rule of his/her own according to the association rules of other users in the intelligent household system to generate an optimized association rule.

For example, in the intelligent household system, more than 80% of users have an association rule that if the door lock is unlocked, the illuminating light is turned on and the air conditioner is turned on in a refrigeration mode, while a user has an association rule that if the door lock is unlocked, the illuminating light is turned on. In this case, the user may optimize his/her own association rule, to generate a final association rule that if the door lock is unlocked, the illuminating light is turned on and the air conditioner is turned on in a refrigeration mode.

In a second manner, the generated association information is recommendation information. After generating the recommendation information, a user may set an association rule according to the recommendation information so that the electronic device generates the association rule.

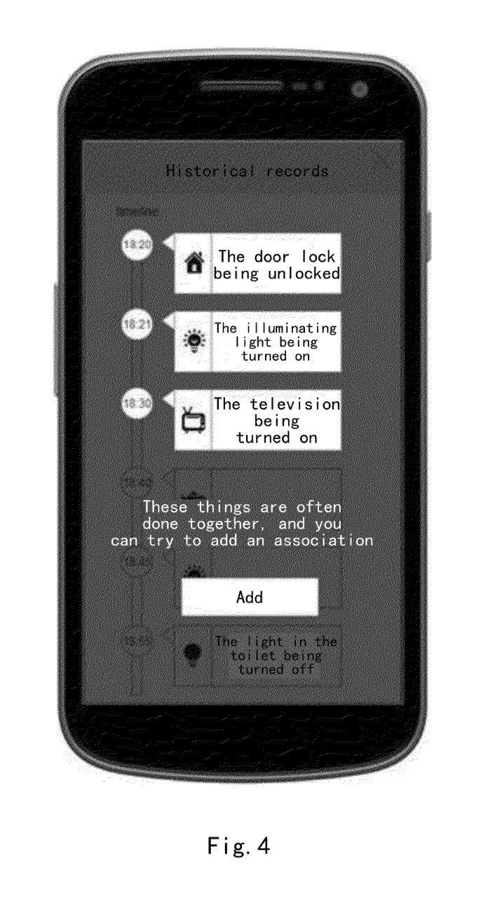

Specifically, it is assumed that N record items in the record list which meet the predetermined rule are the following three record items: the door lock being unlocked, the illuminating light being turned on, and the television being turned on. The generated recommendation information may be “the three things are often done together, need to add an association rule?” In practical applications, the content of the recommendation information may be adjusted as needed, which is not limited in the present disclosure, as shown in FIG. 4. Then, the electronic device determines whether to add the association rule according to the user's selection.

In the embodiment of the present disclosure, after the user determines that it needs to add the association rule, the association rule selected by the user is generated, and is stored in the electronic device.

Then, when a response result of any of the N intelligent household devices is acquired, the response result is matched with the multiple association rules stored in the electronic device. When the matching is successful, control instructions for controlling other intelligent household devices associated therewith are generated and the control instructions are transmitted respectively to said other intelligent household devices associated therewith.

In the second manner, the electronic device acquires records suitable for user habits by analyzing the response result of the user's operation action, and recommends a suitable association rule to the user according to the records, so that the association rule set by the user is more accurate and close to the practical situations.

Specifically, the user may log in the electronic device according to the embodiment of the present disclosure through a terminal device connected to the electronic device, and view historical record items of multiple intelligent household devices connected thereto. After the user logs in, the electronic device may transmit the above recommendation information to the terminal device. In the embodiment of the present disclosure, the terminal device may be a smart phone or a tablet or the like, which is not limited in the disclosure.

In the second manner, similarly, as association rules of other users are comprised in the intelligent household system, before generating the recommendation information, the electronic device may automatically acquire association rules of other users in the network, and then optimize the recommendation information of his/her own according to the association rules of other users in the intelligent household system, and outputs an optimized recommendation information.

For example, in the intelligent household system, more than 80% of users have an association rule that if the door lock is unlocked, the illuminating light is turned on and the air conditioner is turned on in a refrigeration mode, while the association rule in the recommendation information of his/her own is that if the door lock is unlocked, the illuminating light is turned on. Then, the recommendation information of his/her own may be optimized to generate final recommendation information comprising “two things of the door lock being unlocked and the illuminating light being turned on are often done together, need to add an association rule?” and “for more than 80% of users, three things of the door lock being unlocked, the illuminating light being turned on and the air conditioner being turned on in a refrigeration mode are often done together, need to add an association rule?” Then, it is determined whether to add an association rule according to the user's selection, and if an association rule is to be added, it is determined which association rule is to be added.

Then, when the user confirms that it needs to add an association rule, the association rule selected by the user is generated, and stored in the electronic device.

For example, if the user selects to add an association rule that “if the door lock is unlocked, the illuminating light is turned on and the air conditioner is turned on in a refrigeration mode”, the association rule that “if the door lock is unlocked, the illuminating light is turned on and the air conditioner is turned on in a refrigeration mode” is stored in the electronic device.

Then, when a response result of any of the N intelligent household devices is acquired, the response result is matched with the multiple association rules stored in the electronic device. When the matching is successful, control instructions for controlling other intelligent household devices associated therewith are generated and the control instructions are transmitted respectively to said other intelligent household devices associated therewith.

Specifically, when the association rule is “if the door lock is unlocked, the illuminating light is turned on and the air conditioner is turned on in a refrigeration mode”, after the electronic device acquires the response result of the intelligent door lock being unlocked which is reported by the intelligent door lock, the electronic device transmits a control instruction to the illuminating light to control the illuminating light to turn on, and transmits a control instruction to the air conditioner to control the air conditioner to turn on in a refrigeration mode.

### Second Embodiment

In the first embodiment, the record item of each intelligent household device only comprises a response result generated by the intelligent household device in response to the user's operation action, and in the second embodiment, each record item further comprises the user's operation action on each intelligent household device.

Specifically, the intelligent household device can detect the user's operation action and the response result of the intelligent household device, and then reports the detected user's operation action and the response result of the intelligent household device to the electronic device connected thereto through the established connection channel. After receiving the user's operation action and the response result of the intelligent household device which are reported by the intelligent household device, the electronic device stores the response result of the intelligent household device as a first parameter of the record item of the intelligent household device, and stores the user information as a second parameter of the record item of the intelligent household device.

For example, the intelligent door lock reports to the electronic device the user's operation action of inserting a key into a key hole and twisting the key, or pressing a finger on a fingerprint recognition apparatus.

Then, in the second embodiment of the present disclosure, the generated association rule is that if the user's operation action on an intelligent household device is acquired by the electronic device, the electronic device controls other intelligent household devices associated with the intelligent household device to complete a correlation response.

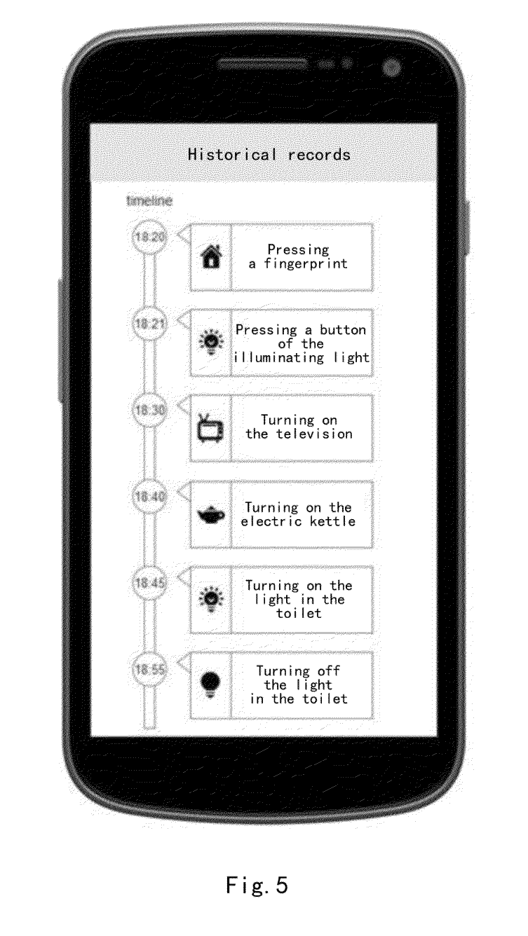

Specifically, when the record item comprises the user's operation action, as shown in FIG. 5, the record items acquired by the electronic device may be pressing a fingerprint so that the door lock is unlocked, and the user pressing the switch button so that the illuminating light is turned on.

Assuming that the above two record items meet the predetermined rule, the generated association rule is that if the user presses a fingerprint, the illuminating light is controlled to turn on.

In the embodiment of the present disclosure, when the user inserts a key into a key hole and twists the key, the electronic device will not be triggered to transmit a control instruction to the illuminating light to control the illuminating light to turn on. Similarly, when the electronic device transmits a control instruction to unlock the door lock, the electronic device also will not be triggered to transmit a control instruction to the illuminating light to control the illuminating light to turn on. When the electronic device detects that the user presses a fingerprint on the fingerprint recognition apparatus of the intelligent door lock, the electronic device transmits a control instruction to the illuminating light to control the illuminating light to turn on.

In the second embodiment of the present disclosure, the associative responses of the intelligent household device is controlled by the user's operation action on the intelligent household device, so that the associative responses of the intelligent household device is more dependent on the user's operation action and more humanized.

### Third Embodiment

In the first embodiment, the record item of each intelligent household device only comprises the response result generated by the intelligent household device to the user's operation action. In the third embodiment, each record item further comprises user information for a user corresponding to the operation action on the each intelligent household device.

Specifically, the intelligent household device can detect the user information and the response result of the intelligent household device, and then reports the detected user information and the response result of the intelligent household device to the electronic device connected thereto through the established connection channel. After receiving the user information and the response result of the intelligent household device which are reported by the intelligent household device, the electronic device stores the response result of the intelligent household device as a first parameter of the record item of the intelligent household device, and stores the user's operation action as a third parameter of the record item of the intelligent household device.

In a specific implementation, the user information may be acquired by means of fingerprint recognition, Near-Field Communication (NFC) or the like.

For example, for the record item of the door lock being unlocked, the record item should further comprise identity information of the user, for example, the user being SanZhang or SiLi.

Specifically, when the record item comprises user information, the record item acquired by the electronic device may be a user named SanZhang unlocking the door lock, a user named SanZhang turning the illuminating light on, or a user named SiLi turning the television on. Further, in the third embodiment, when the association rule is generated, it needs to generate respective association rules of different users according to record items of the different users.

In the third embodiment of the present disclosure, the generated association rule is that if the user information reported by an intelligent household device is acquired by an electronic device, the electronic device controls other intelligent household devices associated with the intelligent household device to complete the correlation response.

Specifically, when a user named SanZhang logs in to view historical records of the intelligent household device using a mobile phone, the electronic device generates an association rule which comply with the habits of the operation action of the user named SanZhang according to the historical record items of the user named SanZhang, or generates recommendation information which complies with the habits of the operation action of the user named SanZhang according to the historical record items of the user named SanZhang, and then generates the association rule according to the user's selection.

Specifically, assuming that the above two record items of the user named SanZhang meet the predetermined rule, the generated association rule is that if the user information reported by the intelligent door lock which is acquired by the electronic device is SanZhang, the illuminating light is controlled to turn on.

When the user information acquired by the electronic device is SanZhang, the electronic device transmits a control instruction to the illuminating light to control the illuminating light to turn on.

In the third embodiment of the present disclosure, the associative responses of the intelligent household device is controlled through the identity information of the user, so that the associative responses of the intelligent household device complies with different user habits and is more personalized for a multi-user intelligent household system.

### Fourth Embodiment

In the second embodiment, the record item of each intelligent household device comprises the response result of the intelligent household device and the corresponding user's operation action. In the fourth embodiment of the present disclosure, the record item of each intelligent household device further comprises user information for a user corresponding to the operation action on the each intelligent household device.

Specifically, the intelligent household device can detect the user's operation action, the user information, and the response result of the intelligent household device, and then reports to the electronic device connected thereto the detected operation action, user information, and response result of the intelligent household device through the established connection channel. After receiving the operation action, the user information, and the response result of the intelligent household device which are reported by the intelligent household device, the electronic device stores the response result of the intelligent household device as a first parameter of the record item of the intelligent household device, stores the user's operation action as a second parameter of the record item of the intelligent household device, and stores the user information as a third parameter of the record item of the intelligent household device. For example, for a record item of a user unlocking the door lock by pressing a fingerprint, the record item should further comprise identity information of the user, for example, the user being SanZhang or SiLi.

In a specific implementation, the user information may be acquired by means of fingerprint recognition, NFC or the like.

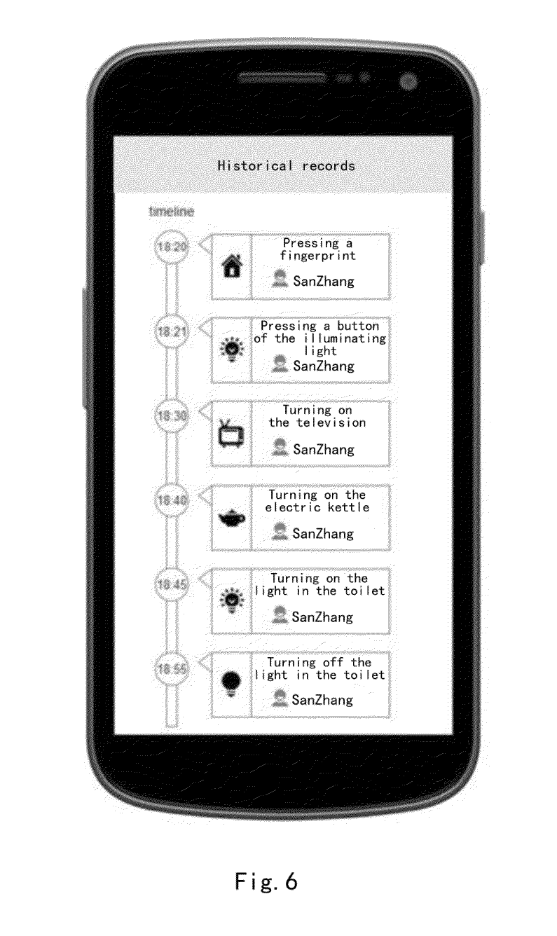

Specifically, when the record item comprises user information, as shown in FIG. 6, the record items acquired by the electronic device may be a user named SanZhang unlocking the door lock by pressing a fingerprint, a user named SanZhang turning the illuminating light on by pressing a switch button, and a user named SiLi turning the television on by pressing a power button of a remote controller.

Specifically, in the fourth embodiment, when an association rule is generated, it needs to generate respective association rules of different users according to record items of the different users.

Then, in the fourth embodiment of the present disclosure, the generated association rule may be that if the electronic device acquire the user information, the user's operation action, and the response result of the intelligent household device, the electronic device controls other intelligent household devices associated with the intelligent household device to complete the correlation response.

Alternatively, if the electronic device acquires the user information and the response result of the intelligent household device, the electronic device controls other intelligent household devices associated with the intelligent household device to complete the correlation response. For example, when a user named SanZhang logs in to view historical records of the intelligent household device using a mobile phone, the electronic device generates an association rule which complies with the habits of the operation action of the user named SanZhang according to the historical record items of the user named SanZhang, or generates recommendation information which complies with the habits of the operation action of the user named SanZhang according to the historical record items of the user named SanZhang, and then generates the association rule according to the user's selection.

Specifically, assuming that the above two record items of the user named SanZhang meet the predetermined rule, the generated association rule is that if the user named SanZhang unlocks the door lock by pressing a fingerprint, the illuminating light is controlled to turn on.

When the user named SanZhang unlocks the door lock by inserting a key into a key hole and twisting the key, the electronic device will not be triggered to transmit a control instruction to the illuminating light to control the illuminating light to turn on. Similarly, when the user named SiLi unlocks the door lock by pressing a fingerprint, the electronic device also will not be triggered to transmit a control instruction to the illuminating light to control the illuminating light to turn on. When the electronic device detects that the user named SanZhang unlocks the door lock by pressing a fingerprint, the electronic device transmits a control instruction to control the illuminating light to turn on.

In the fourth embodiment of the present disclosure, the associative responses of the intelligent household device may be controlled through the identity information of the user, the user's operation action on the intelligent household device and the response result of the intelligent household device, so that the associative responses of the intelligent household device complies with different user habits and is more personalized for a multi-user intelligent household system.

### Fifth Embodiment

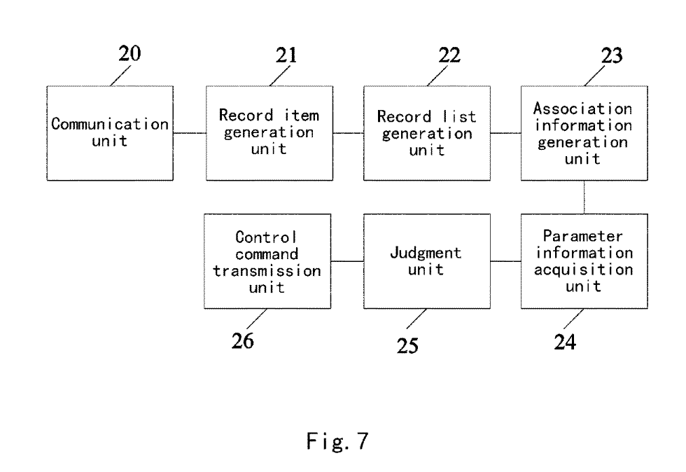

Based on the same inventive concept, the embodiment of the present disclosure provides an electronic device. As shown in FIG. 7, the electronic device comprises: a communication unit 20 configured to establish a connection channel to each of multiple intelligent household devices positioned in a physical space, wherein a change in an operating state of said each intelligent household device can cause a change in an environmental state of the physical space; a record item generation unit 21 configured to generate a record item of said each intelligent household device by acquiring a response result generated by said each intelligent household device in response to a user's operation action through the connection channel to said each intelligent household device and use the response result as a first parameter of the record item; a record list generation unit 22 configured to generate a record list by recording a record item corresponding to each operation of the user on each of the multiple intelligent household devices in a chronological order; and an association information generation unit 23 configured to generate association information by processing the record list in accordance with a predetermined rule, wherein the association information comprises N record items which are contiguous, so that N intelligent household devices in a one-to-one correspondence with the N record items make associative responses, wherein N is a positive integer larger than or equal to 2.

Alternatively, the association information is an association rule, and the electronic device further comprises: a parameter information acquisition unit 24 configured to, after the generating of association information by processing the record list in accordance with a predetermined rule, acquire parameter information in the process of generating a response result by a first intelligent household device of the N intelligent household devices in response to the user's operation action through a first connection channel established between the first intelligent household device and the electronic device; a judgment unit 25 configured to judge whether the parameter information matches with the association rule; a control command transmission unit 26 configured to, when the parameter information matches with the association rule, when a first response result generated by the first intelligent household device of the N intelligent household devices is acquired through the first connection channel established between the first intelligent household device and the electronic device, transmit a control instruction to a second intelligent household device of the N intelligent household devices through a second connection channel established between the second intelligent household device and the electronic device, so that the second intelligent household device generates a second response result in response to the control instruction, wherein the second response result generated by the second intelligent household device in response to the control instruction is equivalent to a response result generated by the second intelligent household device in response to a user's operation action.

Alternatively, the electronic device further comprises: a record item change unit 21 configured to, after the judging of whether the parameter information matches with the association rule, when the parameter information matches with the association rule, change to a correlation record item a record item representing existence of the process of generating a response result by the first intelligent household device in response to the user's operation action; or after the judging of whether the parameter information matches with the association rule, when the parameter information does not match with the association rule, generate a new record item representing existence of the process of generating a response result by the first intelligent household device in response to the user's operation action.

Alternatively, the record item generation unit 21 is further configured to, after the generating of a record item of said each intelligent household device by acquiring a response result generated by said each intelligent household device in response to a user's operation action through the connection channel to said each intelligent household device, acquire the user's operation action on said each intelligent household device through the connection channel to said each intelligent household device; and use the user's operation action on said each intelligent household device as a second parameter of the record item of said each intelligent household device.

Alternatively, the record item generation unit is further configured to, after the generating of a record item of said each intelligent household device by acquiring a response result generated by said each intelligent household device in response to a user's operation action through the connection channel to said each intelligent household device, acquire user information for a user corresponding to the operation action on said each intelligent household device through the connection channel to said each intelligent household device; and use the user information for the user corresponding to the operation action on said each intelligent household device as a third parameter of the record item of said each intelligent household device.

Alternatively, the predetermined rule further comprises: an interval among the N record items in the record list is less than an interval threshold; and/or a number of occurrences of the N record items in the record list is greater than a number threshold.

The above one or more technical solutions according to the embodiment of the present disclosure at least comprise the following one or more technical effects.

1. In the solution according to the embodiment of the present disclosure, a record item of each intelligent household device is detected and generated, wherein the record item comprises a response result of said each intelligent household device, a record list is generated according to record items of various intelligent household devices, and then corresponding association information is generated according to a predetermined rule, so that multiple intelligent household devices in a one-to-one correspondence with multiple record items make associative responses. With the solution according to the embodiment of the present disclosure, multiple intelligent household devices associated with an intelligent household device can make a correlation response after a response is made to a user's operation action on the intelligent household device without a user setting various intelligent household devices individually, thereby eliminating the technical problem in the related art that the method for controlling an intelligent household device is too simple and not intelligent and providing a novel and more intelligent control manner.

2. In the solution according to the embodiment of the present disclosure, after the association information is generated, when a first response result generated by a first intelligent household device is acquired, a control instruction is transmitted to a second intelligent household device so that the second intelligent household device generates a second response result in response to the control instruction, wherein the second response result generated by the second intelligent household device in response to the control instruction is equivalent to a response result generated by the second intelligent household device in response to a user's operation action. Thus, in the embodiment of the present disclosure, multiple intelligent household devices can be controlled by setting the intelligent household devices to automatically generate associative responses according to the record items without a user controlling the intelligent household devices individually, so that the control of the intelligent household devices is more intelligent.

3. In the solution according to the embodiment of the present disclosure, the user's operation action on each intelligent household device is acquired when the record item of said each intelligent household device is generated, and then association control is performed on the intelligent household device only when the response result of the intelligent household device and the operation action are detected at the same time, and the association control is not performed on the intelligent household device when only the response result of the intelligent household device is detected, so that the association control of the intelligent household devices is more accurate.

4. In the solution according to the embodiment of the present disclosure, the user information for a user corresponding to the operation action on each intelligent household device is acquired when the record item of the intelligent household device is generated, and then different association control is performed according to different user information, so that the association control of the intelligent household device is more accurate and can be applied to different use habits of different users.

5. In the solution according to the embodiment of the present disclosure, the predetermined rule further comprises: an interval among the N record items in the record list is less than an interval threshold; and/or a number of occurrences of the N record items in the record list is greater than a number threshold. Thus, in the solution regarding association information according to the embodiment of the present disclosure, the association information is generated according to users' use records, i.e., use habits, so that the association information can accurately reflect the user habits and requirements, thereby enabling the manner of controlling an intelligent household device according to the embodiment of the present disclosure to be more intelligent.

In the technical solutions according to the above and/or other embodiments of the present disclosure, the correlation rule may further be set according to the user's practical operation after the correlation template of the electronic device is started, so that the associative responses of multiple intelligent household devices can be implemented without the user setting various intelligent household devices individually through different software, thereby eliminating the technical problem in the related art that the method for controlling an intelligent household device is too simple and not intelligent enough and providing a novel and more intelligent control manner.

As described above, the electronic device according to some embodiments of the present disclosure may be a cloud server, a central control device or the like. In a specific use process, the above electronic device may display through a remote display client, or may display through a display unit of the electronic device itself. For example, the electronic device may be a mobile phone, and after acquiring the set correlation rule, the mobile phone synchronizes the correlation rule to a server or a central control platform.

### Sixth Embodiment

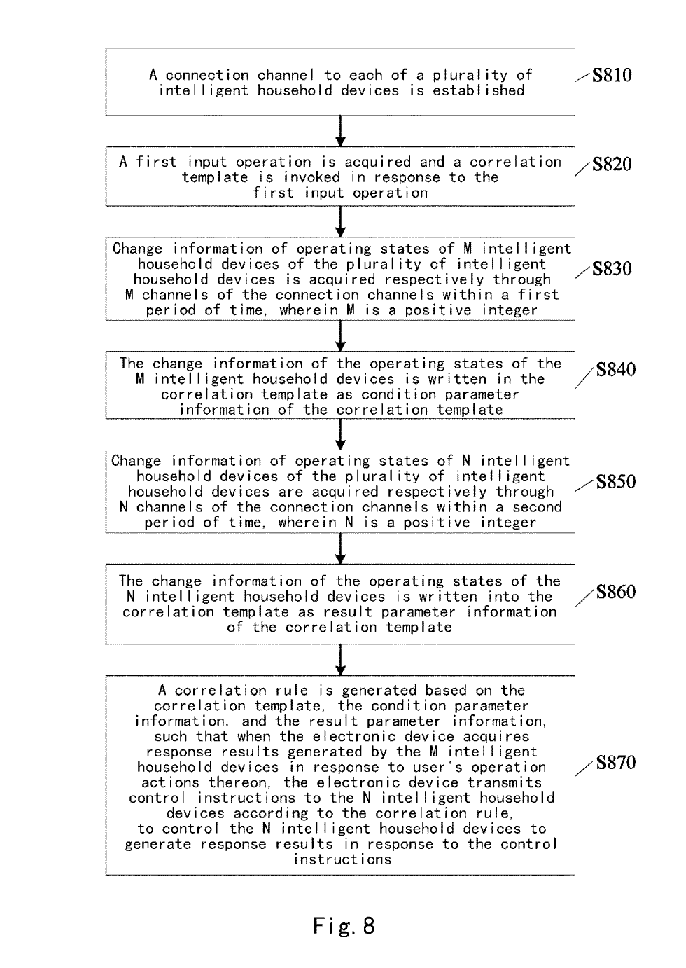

The sixth embodiment of the present disclosure provides an information processing method applied in an electronic device. As shown in FIG. 8, the method comprises the following steps.

In S810, a connection channel to each of multiple intelligent household devices is established.

The multiple intelligent household devices are positioned in a physical space, and a change in an operating state of said each intelligent household device can cause a change in an environmental state of the physical space; and a response result generated by said each intelligent household device in response to a control instruction transmitted by the electronic device is equivalent to a response result generated by said each intelligent household device in response to a user's operation action thereon.

Specifically, the intelligent household device may be directly connected to a cloud server through WiFi, or may be connected to an HUB and a router, or may transmit/receive data to/from an electronic device through NFC, which is not limited in the present disclosure.

Then, step S820 will be described.

In S820, a first input operation is acquired and a correlation template is invoked in response to the first input operation.

Specifically, when the electronic device is a central control device, as the central control device per se has no screen, a user may control the central control device through voice input, and after acquiring the user's voice input operation, the central control device invokes the correlation template. Alternatively, when the electronic device displays through a remote display client, the user may interact with the central control device through a display screen and a sensor unit of the remote display client. In this case, the first input operation is a user's operation on the remote display client, such as touching a virtual key on the display screen.

In the embodiment of the present disclosure, the electronic device may be an intelligent management device having a display screen and a sensor unit, for example, a mobile phone, and the user may implement an operation through a display screen and a touch unit of the mobile phone.

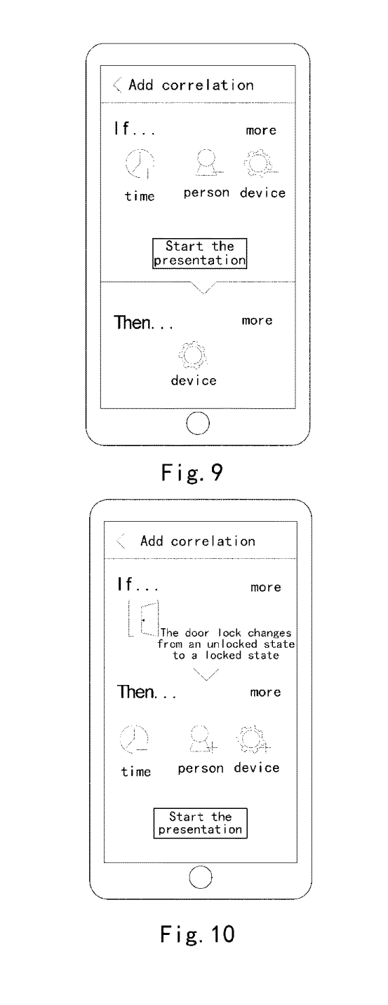

In the embodiment of the present disclosure, the correlation template may be a template which is invoked when the user sets a correlation rule. As shown in FIG. 9, the user may add an “If” condition and a “Then” result on the correlation template to generate a correlation rule. In practical applications, the correlation template may have different display interfaces. In step S820, after detecting the user's first input operation, the electronic device invokes the correlation template and displays the correlation template on the display screen of the electronic device or the display screen of the remote display client connected to the electronic device.

In the embodiment of the present disclosure, as shown in FIG. 9, the correlation rule may be set by implementing an operation on a Graphical User Interface (GUI) displayed on a screen of a mobile phone. The correlation rule is formed by selecting an “If condition” device and a “Then result” device in the mobile phone and associating these devices using “If this then that”. The user may perform selection and combination among a large number of device lists and attribute lists to form the correlation rule. For example, if an air detector acts as the “IF device” and an air conditioner acts as the “Then device”, the correlation rule is set as “If the air cleaner detects poor air quality, Then the air conditioner is turned on.” With a correlation rule base comprised of multiple similar correlation rules, the intelligent household devices can be controlled to operate intelligently and cooperatively according to user habits, thereby bringing real convenience to users.

However, in the above solution of the present disclosure, the process of setting the correlation rule on the GUI is not intuitive enough, and it is difficult for a user to understand the description of many “conditions” and “results”. In addition, whenever the correlation rule is set, selection and combination are to be performed among a large number of device lists and attribute lists, which is a very complex interaction process and has poor availability.

In the embodiment of the present disclosure, the operating state of the intelligent household device is changed through the user's practical operation, and real-time change information of the operating states of these intelligent household devices are used as condition parameter information (If condition) and result parameter information (Then result) in the correlation rule, and then the correlation rule is generated through the user's practical presentation operation. In this way, the manner of adding a correlation rule in the embodiment of the present disclosure is more intuitive and natural, and is easy to operate, thereby improving the availability of the correlation rule.

Then, steps S830-S870 are descried to explain how to generate the correlation rule through the user's practical presentation operation.

In S830, change information of operating states of M intelligent household devices of the multiple intelligent household devices is acquired respectively through M channels of the connection channels within a first period of time, wherein M is a positive integer.

The change information of the operating states of the M intelligent household devices is an operating state before a response is made to a user's operation action and an operating state after the response is made to the user's operation action, which are recorded by an intelligent household device which generates a response result in response to the user's operation action within the first period of time.

In the embodiment of the present disclosure, S830 further comprises: acquiring a first presentation operation for indicating the electronic device to acquire an intelligent household device which generates a response result in response to a user's operation action within the first period of time and a change in an operating state of the intelligent household device which generates the response result in response to the user's operation action; and acquiring change information of operating states of M intelligent household devices respectively through the M channels in response to the first presentation operation.

Specifically, as shown in FIG. 9, the first presentation operation may be a user's touch operation on a virtual key on a display screen, and the user touches the virtual key of “start the presentation.”

Then, after the user touches the key of “start the presentation”, the change information of the operating states of the M intelligent household devices is acquired. Specifically, the electronic device actively acquires the change information of the states recorded by the intelligent household devices within the first period of time through the connection channels. For example, if the electronic device detects that the user touches the key of “start the presentation” at a first time, the electronic device acquires the change information of the states of the multiple intelligent household devices after the first time, for example, the door lock changing from an unlocked state to a locked state, and the air conditioner being always in a turn-on state.

In a specific implementation, M may be 1 or 2 or 3 depending on user habits, which is not limited in the present disclosure.

Compared with the related art, in the embodiment of the present disclosure, the user performs selection and combination among a large number of device lists and attributes lists of the electronic device, to form a correlation rule. In the present disclosure, when correlation conditions and correlation results are set, the operating state of the intelligent household device changes with the user's real-time operation on the intelligent household device, so that the electronic device can acquire the change information of the operating state of the intelligent household device.

In the specific implementation, there are many manners for the electronic device to acquire the change information of the operating states of the intelligent household devices. In the embodiment of the present disclosure, the following two manners are described; however, it is not limited to the following two manners.

In a first manner, the electronic device is a central control device, and a smart phone acts as a display client connected to the central control device.

After detecting and acquiring a first presentation operation, the display client notifies the central control device, and the central control device starts to acquire the intelligent household device of which the operating state changes and the change information of the operating state through a connection channel.

In this process, the user changes the operating state of the intelligent household device by performing a certain operation action, for example, the user presses a switch of an illuminating light, or the user operates a remote controller of an air conditioner.

Specifically, the intelligent household device may automatically record the change information of the operating state of its own, and then the central control device acquires the change information of the operating state of the intelligent household device by acquiring these records.

In a second manner, the electronic device is a smart phone, and the phone may acquire the change information of the operating states of the intelligent household devices through Bluetooth or NFC.

By taking NFC as an example, after the smart phone detects and acquires the first presentation operation, the user carries the mobile phone to close to the intelligent household device to be operated, so that the smart phone and the intelligent household device can implement data transmission through NFC, and then the user operates the intelligent household device, so that the operating state of the intelligent household device changes, and the change information of the operating state is transmitted to the smart phone.

Then, step S840 is performed.

In S840, the change information of the operating states of the M intelligent household devices is written in the correlation template as condition parameter information of the correlation template.

Specifically, the electronic device records the change information of the operating states of the intelligent household devices of which the operating states change within a first period of time after the first time, and then the change information of these operating states is written into the correlation template as condition parameter information of the correlation template, i.e., “If condition”.

For example, the condition parameter information may be the door lock changing from an unlocked state to a locked state.

Then, step S850 will be described.

In S850, change information of operating states of N intelligent household devices of the multiple intelligent household devices are acquired respectively through N channels of the connection channels within a second period of time, wherein N is a positive integer.

The change information of operating states of the N intelligent household devices is an operating state before a response is made to a user's operation action and an operating state after the response is made to the user's operation action, which are recorded by an intelligent household device which generates a response result in response to the user's operation action within the second period of time.

In the embodiment of the present disclosure, S850 further comprises: acquiring a second presentation operation for indicating the electronic device to acquire an intelligent household device which generates a response result in response to a user's operation action within the second period of time and a change in an operating state of the intelligent household device which generates the response result in response to the user's operation action; and acquiring change information of operating states of N intelligent household devices respectively through the N channels in response to the second presentation operation.

In the embodiment of the present disclosure, the principle of the second presentation operation is the same as that of the first presentation operation, and will not be described here.

For example, if the electronic device detects that the user touches the key of “start the presentation” at a second time, as shown in FIG. 10, the electronic device acquires the change information of the states of multiple intelligent household devices after the second time, for example, the illuminating light changing from a turn-on state to a turn-off state.

In a specific implementation, N may be 1, or 2, or 3 depending on user habits, which is not limited in the present disclosure.

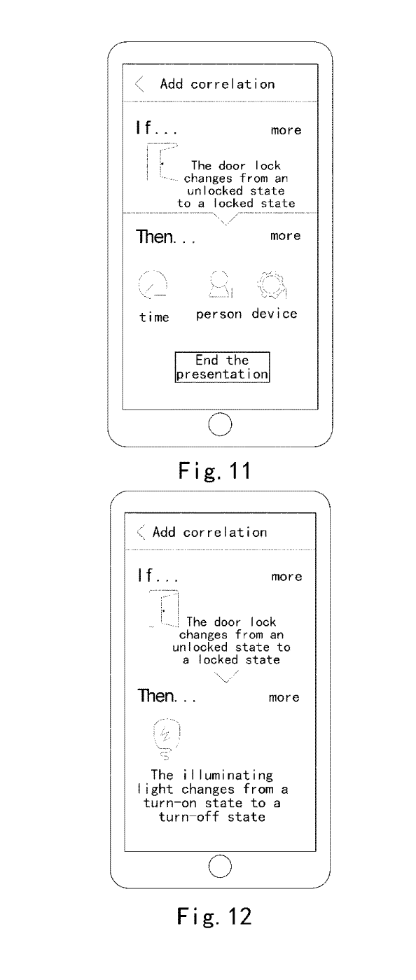

In the specific implementation, after the user touches the key of “start the presentation”, a key of “end the presentation” may be displayed on a display screen of the electronic device, and the user may touch the key as needed to manually control the duration of the response result of the intelligent household device, as shown in FIG. 11.

Then, step S860 is performed. In step S860, the change information of the operating states of the N intelligent household devices is written into the correlation template as result parameter information of the correlation template.

Specifically, the electronic device records the change information of the operating states of the intelligent household devices of which the operating states change within the second period of time after the second time, and then writes the change information of these operating states into the correlation template as the result parameter information of the correlation template, i.e., the “Then result”. For example, the “Then result” may be the illuminating light changing from a turn-on state to a turn-off state.

In a specific implementation, S830 and S840 may be performed before S850 and S860, or may also be performed after S850 and S860, which is not limited in the present application.

In S870, a correlation rule is generated based on the correlation template, the condition parameter information, and the result parameter information, so that when the electronic device acquires a response result generated by the M intelligent household devices in response to a user's operation action thereon, the electronic device transmits a control instruction to the N intelligent household device according to the correlation rule, to control the N intelligent household device to generate a response result in response to the control instruction.

In a specific implementation, S870 further comprises the following steps.

In a first step, a generation instruction is acquired.

In the embodiment of the present disclosure, a generation instruction of a correlation rule may be generated through the user's operation, and as shown in FIG. 11, the user may touch the key of “end the presentation” on the display screen. After the “If condition” and the “Then result” are acquired successfully by the electronic device, the electronic device is triggered by touching the key of “end the presentation” to generate a generation instruction, and the electronic device may automatically generate the instruction after successfully acquiring the “If condition” and the “Then result”. For example, the electronic device automatically generates the instruction a period of time after acquiring the “If condition” and the “Then result”.

In a second step, a correlation rule is generated based on the correlation template, the condition parameter information, and the result parameter information in response to the generation instruction, as shown in FIG. 12.

In the embodiment of the present disclosure, the first period of time is a period from a time when the first presentation operation is acquired to a time when the second presentation operation is acquired, and the second period of time is a period from a time when the second presentation operation is acquired to a time when the generation instruction is acquired. That is, the first period of time is a period from a time when a “start the presentation” operation of the “If condition” is acquired by the electronic device to a time when a “start the presentation” operation of the “Then result” is acquired by the electronic device, and the second period of time is a period from a time when the “start the presentation” operation of the “Then result” is acquired to a time when the generation instruction is acquired.

Further, the change parameter of the operating states of all intelligent household devices acquired within the first period of time are used as the If condition of the correlation rule, and the change parameter of the operating states of all intelligent household devices acquired within the second period of time are used as the Then condition of the correlation rule.

In the above solution, when the correlation rule is added, the operating state of the intelligent household device is changed through the user's practical operation, and real-time change information of the operating states of these intelligent household devices are used as condition parameter information (If condition) and result parameter information (Then result) in the correlation rule, so that the correlation rule is generated through the user's practical presentation operation. In this way, the manner of adding a correlation rule in the embodiment of the present disclosure is more intuitive and natural, and is easy to operate, thereby improving the availability of the correlation rule.

In the embodiment of the present disclosure, after the correlation rule is generated, the correlation rule may be stored in the electronic device; or the correlation rule may be synchronized to a network side device connected to the electronic device.

Specifically, when the electronic device is a central control device or a cloud server, the correlation rule may be stored in the electronic device, and when the electronic device is an intelligent management device, the generated correlation rule may be synchronized to the network side device such as a cloud server connected to the intelligent management device.

In the embodiment of the present disclosure, after the correlation rule is generated, the intelligent household device may make associative responses according to the correlation rule.

First of all, change information of an operating state of a first intelligent household device of the multiple intelligent household devices is acquired.

In a specific implementation, after the operating state of the intelligent household device changes, the intelligent household device transmits the change information of the operating state to the electronic device through the established connection channel.

Then, when the change information of the operating state of the first intelligent household device matches with the condition parameter information in the correlation rule, the control instruction is transmitted to a second intelligent household device to control the intelligent household device to generate a response result in response to the control instruction, wherein the second intelligent household device is an intelligent household device corresponding to the result parameter information in the correlation rule.

Specifically, when the intelligent household device of which the operating state changes and the change information of the operating state match with condition parameter information in any of correlation rules in the electronic device, the electronic device controls the corresponding intelligent household device according to the result parameter information written into the correlation rule.

For example, the correlation rule is that If the door lock changes from an unlocked state to a locked state, Then the illuminating light changes from a turn-on state to a turn-off state. When the electronic device acquires the change information of the operating state of the door lock, i.e., changing from an unlocked state to a locked state, the electronic device transmits a control instruction to the illuminating light to control the illuminating light to turn off.

In the above solution of the present disclosure, the condition parameter information of the correlation rule only comprises a response result of the intelligent household device in response to the user's operation action. In a specific implementation, as an alternative, the condition parameter information may further comprise the user's operation action on the intelligent household device.

Specifically, the intelligent household device can detect the user's operation action and the response result of the intelligent household device, and then reports the detected user's operation action and response result of the intelligent household device to the electronic device connected thereto through the established connection channel. After receiving the user's operation action and the response result of the intelligent household device which are reported by the intelligent household device, the electronic device writes the user's operation action into the correlation template as second condition parameter information of the correlation template.

For example, the intelligent door lock reports to the electronic device the user's operation action of inserting a key into a key hole and twisting the key or pressing a finger on a fingerprint recognition apparatus.

Then, the correlation rule generated by the electronic device may be that If the door lock changes from an unlocked state to a locked state in response to the user inserting the key into the key hole and twisting the key, Then the illuminating light changes from a turn-on state to a turn-off state.

In a specific implementation, when the electronic device detects that the door lock changes from an unlocked state to a locked state in response to inserting the key into the key hole and twisting the key, the electronic device transmits a control instruction to the illuminating light to control the illuminating light to change from a turn-on state to a turn-off state; while when the electronic device detects that the door lock changes from an unlocked state to a locked state in response to the user pressing a finger on the fingerprint recognition apparatus, the electronic device will not transmit the above control instruction to the illuminating light.

In the above solution of the present disclosure, the user's operation action is written into the correlation rule of the intelligent household device, so that the associative responses of the intelligent household devices is more dependent on the user's operation action and more humanized.

In the embodiment of the present disclosure, as an alternative, the condition parameter information may further comprise user information acquired by the intelligent household device.

Specifically, the intelligent household device can detect the user information and the response result of the intelligent household device, and then report the detected user information and response result of the intelligent household device to the electronic device connected thereto through the established connection channel. After receiving the user information and the response result of the intelligent household device which are reported by the intelligent household device, the electronic device writes the user information into the correlation template as third condition parameter information of the correlation template.

In a specific implementation, the user information may be acquired by means of fingerprint recognition, NFC or the like.

For example, when the door lock changes from an unlocked state to a locked state, the door lock detects that a user who performs the operation is SanZhang.

Then, the correlation rule generated by the electronic device may be that If the user named SanZhang changes the door lock from an unlocked state to a locked state, Then the illuminating light changes from a turn-on state to a turn-off state.

In a specific implementation, when the electronic device detects that the user named SanZhang changes the door lock from an unlocked state to a locked state, the electronic device transmits a control instruction to the illuminating light to control the illuminating light to change from a turn-on state to a turn-off state; while when a user named SiLi changes the door lock from an unlocked state to a locked state, the electronic device will not transmit the above control instruction to the illuminating light.

In the above solution of the present disclosure, the user information is written into the correlation rule of the intelligent household device, so that the associative responses of the intelligent household device complies with different user habits and is more personalized for a multi-user intelligent household system.

In the embodiment of the present disclosure, as an alternative, the condition parameter information may further comprise the response result of the intelligent household device, the user's operation action and the user information at the same time, and the details thereof will not be described here.

### Seventh Embodiment

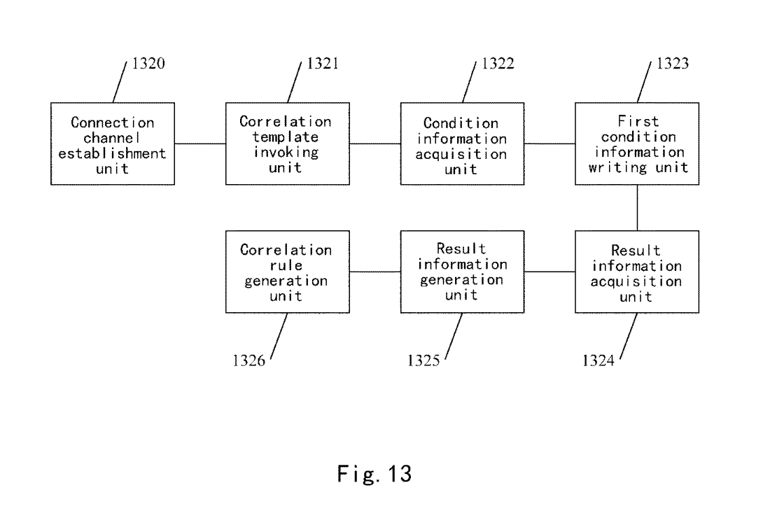

Based on the same inventive concept, some embodiments of the present disclosure further provide an electronic device. As shown in FIG. 13, the electronic device comprises: a connection channel establishment unit 1320 configured to establish a connection channel to each of multiple intelligent household devices positioned in a physical space, wherein a change in an operating state of said each intelligent household device can cause a change in an environmental state of the physical space, wherein a response result generated by said each intelligent household device in response to a control instruction transmitted by the electronic device is equivalent to a response result generated by said each intelligent household device in response to a user's operation action thereon; a correlation template invoking unit 1321 configured to acquire a first input operation and invoke a correlation template in response to the first input operation; a condition information acquisition unit 1322 configured to acquire change information of operating states of M intelligent household devices of the multiple intelligent household devices respectively through M channels of the connection channels within a first period of time, wherein M is a positive integer, and the change information of the operating states of the M intelligent household devices is an operating state before a response is made to a user's operation action and an operating state after the response is made to the user's operation action, which are recorded by an intelligent household device which generates a response result in response to the user's operation action within the first period of time; a first condition information writing unit 1323 configured to write the change information of the operating states of the M intelligent household devices into the correlation template as condition parameter information of the correlation template; a result information acquisition unit 1324 configured to acquire change information of operating states of N intelligent household devices of the multiple intelligent household devices respectively through N channels of the connection channels within a second period of time, wherein N is a positive integer, and the change information of the operating states of the N intelligent household devices is an operating state before a response is made to a user's operation action and an operating state after the response is made to the user's operation action, which are recorded by an intelligent household device which generates a response result in response to the user's operation action within the second period of time; a result information generation unit 1325 configured to write the change information of the operating states of the N intelligent household devices into the correlation template as result parameter information of the correlation template; and a correlation rule generation unit 1326 configured to generate a correlation rule based on the correlation template, the condition parameter information, and the result parameter information, so that when the electronic device acquires a response result generated by the M intelligent household devices in response to a user's operation action thereon, transmit a control instruction to the N intelligent household device according to the correlation rule, to control the N intelligent household device to generate a response result in response to the control instruction.

Alternatively, the electronic device further comprises: a correlation rule storage unit configured to, after the generating of a correlation rule based on the correlation template, the condition parameter information, and the result parameter information, store the correlation rule in the electronic device; or synchronize the correlation rule to a network side device connected to the electronic device.

Alternatively, the electronic device further comprises: a state information acquisition unit configured to, after the generating of a correlation rule based on the correlation template, the condition parameter information, and the result parameter information, acquire change information of an operating state of a first intelligent household device of the multiple intelligent household devices; and a control instruction transmission unit configured to, when the change information of the operating state of the first intelligent household device matches with the condition parameter information in the correlation rule, transmit the control instruction to a second intelligent household device to control the intelligent household device to generate a response result in response to the control instruction, wherein the second intelligent household device is an intelligent household device corresponding to the result parameter information in the correlation rule.

Alternatively, the condition information acquisition unit 1322 further comprises: a first presentation operation acquisition sub-unit configured to acquire a first presentation operation for indicating the electronic device to acquire an intelligent household device which generates a response result in response to a user's operation action within the first period of time and a change in an operating state of the intelligent household device which generates the response result in response to the user's operation action; and a condition information acquisition sub-unit configured to acquire change information of operating states of M intelligent household devices respectively through the M channels in response to the first presentation operation.

Alternatively, the result information acquisition unit 1324 further comprises: a second presentation operation acquisition sub-unit configured to acquire a second presentation operation for indicating the electronic device to acquire an intelligent household device which generates a response result in response to a user's operation action within the second period of time and a change in an operating state of the intelligent household device which generates the response result in response to the user's operation action; and a result information acquisition sub-unit configured to acquire change information of operating states of N intelligent household devices respectively through the N channels in response to the second presentation operation.

Alternatively, the electronic device further comprises: an instruction generation unit configured to, after the acquiring of change information of operating states of N intelligent household devices respectively through the N channels in response to the second presentation operation, acquire a generation instruction; and the correlation rule generation unit 1326 configured to generate a correlation rule based on the correlation template, the condition parameter information, and the result parameter information in response to the generation instruction; wherein, the first period of time is a period from a time when the first presentation operation is acquired to a time when the second presentation operation is acquired, and the second period of time is a period from a time when the second presentation operation is acquired to a time when the generation instruction is acquired.

Alternatively, the electronic device further comprises: an operation action acquisition unit configured to, after the acquiring of change information of operating states of M intelligent household devices of the multiple intelligent household devices respectively through M channels of the connection channels, acquire a user's operation action on the M intelligent household devices; and a second condition information writing unit configured to write the user's operation action on the M intelligent household devices into the correlation template as second condition parameter information of the correlation template.

Alternatively, the electronic device further comprises: a user information acquisition unit configured to, after the acquiring of change information of operating states of M intelligent household devices of the multiple intelligent household devices respectively through M channels of the connection channels, acquire user information acquired by the M intelligent household devices; and a third condition information writing unit configured to write the user information for the M intelligent household devices into the correlation template as third condition parameter information of the correlation template.

One or more technical solutions according to some embodiment of the present disclosure at least comprise the following one or more technical effects: In the solutions according to some embodiments of the present disclosure, a connection channel to each of multiple intelligent household devices is established, then a first input operation is acquired, and a correlation template is invoked in response to the first input operation; and then a response result generated by the intelligent household device in response to a user's operation action is acquired through the connection channel, and then different response results are written into the correlation template as condition parameter information and result parameter information of the correlation template to generate a correlation rule, so that when the electronic device acquires a response result of an intelligent household device, the electronic device transmits a control instruction to other intelligent household devices according to the correlation rule, to control the other intelligent household devices to generate a response result in response to the control instruction. Thus, in the embodiments of the present disclosure, the correlation rule may be set according to the user's practical operation after the correlation template of the electronic device is started, so that the associative responses of multiple intelligent household devices can be implemented without the user setting various intelligent household devices individually through different software, thereby eliminating the technical problem in the related art that the method for controlling an intelligent household device is too simple and not intelligent enough and providing a novel and more intelligent control manner.

Those skilled in the art should appreciate that the embodiments of the present disclosure can be provided as methods, systems, or computer program products. Therefore, forms such as hardware-only embodiments, software-only embodiments, or embodiments combining software and hardware can be used in the present disclosure. In addition, forms such as a computer program product which is implemented on one or more of computer usable storage media (comprising but not limited to a disk memory, a CD-ROM, an optical memory etc.) with computer usable program codes can be used in the present disclosure.

The present disclosure is described with reference to the flowcharts and/or block diagrams of the methods, devices (systems) and computer program products according to the embodiments of the present disclosure. It should be understood that each flow and/or block in the flowcharts and/or block diagrams as well as a combination of the flows and/or blocks in the flowcharts and/or block diagrams can be implemented by computer program instructions. These computer program instructions can be provided to a processor of a general-purpose computer, a dedicated-purpose computer, an embedded processor, or other programmable data processing devices to generate a machine. Thereby, the instructions executed by the processor of the computer or other programmable data processing devices generate means for implementing functions specified in one or more flows in the flowcharts and/or one or more blocks in the block diagrams.

These computer program instructions can also be stored in a computer readable memory capable of introducing a computer or other programmable data processing devices to operate in a particular mode. Thereby, the instructions stored in the computer readable memory generate an article of manufacture comprising instruction means for implementing functions specified in one or more flows in the flowcharts and/or one or more blocks in the block diagrams.

These computer program instructions can also be loaded onto a computer or other programmable data processing devices, so as to enable a series of operation steps to be performed on the computer or other programmable devices to generate a computer-implemented process. Thereby, the instructions executed on the computer or other programmable devices provide a step of implementing functions specified in one or more flows in the flowcharts and/or one or more blocks in the block diagrams.

Specifically, computer program instructions corresponding to the information processing method according to some embodiments of the present disclosure may be stored on a storage medium such as an optical disk, a hard disk, a USB device etc. When the computer program instructions in the storage medium corresponding to the information processing method are read or executed by an electronic device, the following steps are performed: establishing a connection channel to each of multiple intelligent household devices positioned in a physical space, wherein a change in an operating state of said each intelligent household device can cause a change in an environmental state of the physical space; generating a record item of said each intelligent household device by acquiring a response result generated by said each intelligent household device in response to a user's operation action through the connection channel to said each intelligent household device, and using the response result as a first parameter of the record item; generating a record list by recording a record item corresponding to each operation of the user on each of the multiple intelligent household devices in a chronological order; and generating association information by processing the record list in accordance with a predetermined rule, wherein the association information comprises N record items which are contiguous, so that N intelligent household devices in a one-to-one correspondence with the N record items make associative responses, wherein N is a positive integer larger than or equal to 2.

Alternatively, the association information is an association rule, and after some other computer instructions stored in the storage medium, which correspond to the step of generating association information by processing the record list in accordance with a predetermined rule, are executed, the following steps are further performed: acquiring parameter information in the process of generating a response result by a first intelligent household device of the N intelligent household devices in response to the user's operation action through a first connection channel established between the first intelligent household device and the electronic device; judging whether the parameter information matches with the association rule; when the parameter information matches with the association rule, transmitting a control instruction to a second intelligent household device of the N intelligent household devices through a second connection channel established between the second intelligent household device and the electronic device, so that the second intelligent household device generates a second response result in response to the control instruction, wherein the second response result generated by the second intelligent household device in response to the control instruction is equivalent to a response result generated by the second intelligent household device in response to a user's operation action.

Alternatively, the association information is an association rule, and after some other computer instructions stored in the storage medium, which correspond to the step of judging whether the parameter information matches with the association rule, are executed, the following steps are further performed: when the parameter information matches with the association rule, changing to a correlation record item a record item representing existence of the process of generating a response result by the first intelligent household device in response to the user's operation action; or when the parameter information does not match with the association rule, generating a new record item representing existence of the process of generating a response result by the first intelligent household device in response to the user's operation action.

Alternatively, when computer instructions stored in the storage medium, which correspond to the step of generating a record item of said each intelligent household device by acquiring a response result generated by said each intelligent household device in response to a user's operation action through the connection channel to said each intelligent household device, are executed, the following steps are further performed: acquiring the user's operation action on said each intelligent household device through the connection channel to said each intelligent household device; and using the user's operation action on said each intelligent household device as a second parameter of the record item of said each intelligent household device.

Alternatively, when computer instructions stored in the storage medium, which correspond to the step of generating a record item of said each intelligent household device by acquiring a response result generated by said each intelligent household device in response to a user's operation action through the connection channel to said each intelligent household device, are executed, the following steps are further performed: acquiring user information for a user corresponding to the operation action on said each intelligent household device through the connection channel to said each intelligent household device; and using the user information for the user corresponding to the operation action on said each intelligent household device as a third parameter of the record item of said each intelligent household device.

Alternatively, the predetermined rule further comprises: an interval among the N record items in the record list is less than an interval threshold; and/or a number of occurrences of the N record items in the record list is greater than a number threshold.

In addition, computer program instructions corresponding to the information processing method according to some embodiments of the present disclosure may be stored on a storage medium such as an optical disk, a hard disk, a USB device etc. When the computer program instructions in the storage medium corresponding to the information processing method are read or executed by an electronic device, the following steps are performed: establishing a connection channel to each of multiple intelligent household devices positioned in a physical space, wherein a change in an operating state of said each intelligent household device can cause a change in an environmental state of the physical space, wherein a response result generated by said each intelligent household device in response to a control instruction transmitted by the electronic device is equivalent to a response result generated by said each intelligent household device in response to a user's operation action thereon; acquiring a first input operation and invoking a correlation template in response to the first input operation; acquiring change information of operating states of M intelligent household devices of the multiple intelligent household devices respectively through M channels of the connection channels within a first period of time, wherein M is a positive integer, and the change information of the operating states of the M intelligent household devices is an operating state before a response is made to a user's operation action and an operating state after the response is made to the user's operation action, which are recorded by an intelligent household device which generates a response result in response to the user's operation action within the first period of time; writing the change information of the operating states of the M intelligent household devices into the correlation template as condition parameter information of the correlation template; acquiring change information of operating states of N intelligent household devices of the multiple intelligent household devices respectively through N channels of the connection channels within a second period of time, wherein N is a positive integer, and the change information of the operating states of the N intelligent household devices is an operating state before a response is made to a user's operation action and an operating state after the response is made to the user's operation action, which are recorded by an intelligent household device which generates a response result in response to the user's operation action within the second period of time; writing the change information of the operating states of the N intelligent household devices into the correlation template as result parameter information of the correlation template; generating a correlation rule based on the correlation template, the condition parameter information, and the result parameter information, so that when the electronic device acquires a response result generated by the M intelligent household devices in response to a user's operation action thereon, transmitting a control instruction to the N intelligent household device according to the correlation rule, to control the N intelligent household device to generate a response result in response to the control instruction.

Alternatively, after some other computer instructions stored in the storage medium, which correspond to the step of generating a correlation rule based on the correlation template, the condition parameter information, and the result parameter information, are executed, the following steps are further performed: storing the correlation rule in the electronic device; or synchronizing the correlation rule to a network side device connected to the electronic device.

Alternatively, after some other computer instructions stored in the storage medium, which correspond to the step of generating a correlation rule based on the correlation template, the condition parameter information, and the result parameter information, are executed, the following steps are further performed: acquiring change information of an operating state of a first intelligent household device of the multiple intelligent household devices; and when the change information of the operating state of the first intelligent household device matches with the condition parameter information in the correlation rule, transmitting the control instruction to a second intelligent household device to control the second intelligent household device to generate a response result in response to the control instruction, wherein the second intelligent household device is an intelligent household device corresponding to the result parameter information in the correlation rule.

Alternatively, when computer instructions stored in the storage medium, which correspond to the step of acquiring change information of operating states of M intelligent household devices of the multiple intelligent household devices respectively through M channels of the connection channels within a first period of time, are executed, the following steps are further performed: acquiring a first presentation operation for indicating the electronic device to acquire an intelligent household device which generates a response result in response to a user's operation action within the first period of time and a change in an operating state of the intelligent household device which generates the response result in response to the user's operation action; and acquiring change information of operating states of M intelligent household devices respectively through the M channels in response to the first presentation operation.

Alternatively, when computer instructions stored in the storage medium, which correspond to the step of acquiring change information of operating states of N intelligent household devices of the multiple intelligent household devices respectively through N channels of the connection channels within a second period of time, are executed, the following steps are further performed: acquiring a second presentation operation for indicating the electronic device to acquire an intelligent household device which generates a response result in response to a user's operation action within the second period of time and a change in an operating state of the intelligent household device which generates the response result in response to the user's operation action; and acquiring change information of operating states of N intelligent household devices respectively through the N channels in response to the second presentation operation.

Alternatively, when computer instructions stored in the storage medium, which correspond to the step of acquiring change information of operating states of N intelligent household devices respectively through the N channels in response to the second presentation operation, are executed, the following steps are further performed: acquiring a generation instruction; and generating a correlation rule based on the correlation template, the condition parameter information, and the result parameter information in response to the generation instruction; wherein, the first period of time is a period from a time when the first presentation operation is acquired to a time when the second presentation operation is acquired, and the second period of time is a period from a time when the second presentation operation is acquired to a time when the generation instruction is acquired.

Alternatively, after some other computer instructions stored in the storage medium, which correspond to the step of acquiring change information of operating states of M intelligent household devices of the multiple intelligent household devices respectively through M channels of the connection channels, are executed, the following steps are further performed: acquiring a user's operation action on the M intelligent household devices; and writing the user's operation action on the M intelligent household devices into the correlation template as second condition parameter information of the correlation template.

Alternatively, after some other computer instructions stored in the storage medium, which correspond to the step of acquiring change information of operating states of M intelligent household devices of the multiple intelligent household devices respectively through M channels of the connection channels, are executed, the following steps are further performed: acquiring user information acquired by the M intelligent household devices; and writing the user information for the M intelligent household devices into the correlation template as third condition parameter information of the correlation template.

Although some embodiments of the present disclosure have been described, additional changes and modifications can be made to these embodiments by those skilled in the art upon learning the basic creative concepts. Therefore, the appended claims are intended to be construed as comprising some embodiments and all changes and modifications that fall into the scope of the present disclosure.

Obviously, those skilled in the art can make various modifications and variations to the present disclosure without departing from the spirit and scope of the present disclosure. Thus, if these modifications and variations of the present disclosure belong to the scope of the claims of the present disclosure and the equivalent technologies thereof, the present disclosure is also intended to include these modifications and variations.

What is claimed is:

1. An information processing method, comprising:
establishing a connection channel among a plurality of electronic devices;
acquiring a plurality of record items through the connection channel, each record item being generated in response to an operation on a respective electronic device;
generating a record list which comprises the plurality of the record items; and
processing the record list to associate at least two record items from the plurality of record items, in order to cause respective operations of the electronic devices, to which said at least two record items correspond, to be performed.

2. The method according to claim 1, further comprising: acquiring parameter information from one of the plurality of electronic devices to generate the corresponding response item in response to said operation;
judging whether the parameter information matches with an association rule with respect to another record item that corresponds to another electronic device of the plurality of electronic devices; and
if the parameter information matches with the association rule, transmitting, through the connection channel, a control instruction to that other electronic device, such that that other electronic device performs its operation.

3. The method according to claim 2, wherein if the parameter information matches with the association rule, including the record item corresponding to that other electronic device in the record list.

4. The method according to claim 1, wherein the acquiring of the plurality of record items further comprises:
acquiring the operation on the corresponding electronic device through the connection channel; and
using the operation on the corresponding electronic device as one of a plurality of parameters of the record item in relation to the corresponding electronic device.

5. The method according to claim 1, wherein the acquiring of the plurality of record items further comprises:
acquiring user information of a user corresponding to the operation on the corresponding electronic device through the connection channel; and
using the user information of the user as another of the plurality of parameters of the record item in relation to the corresponding electronic device.

6. The method according to claim 1, wherein the processing of the record list is based on one or more predetermined rules requiring:
an interval among N record items in the record list to be less than an interval threshold; or
the number of occurrences of N record items in the record list to be greater than a number threshold;
or both.

7. An electronic device, comprising:
a communication unit configured to establish a connection channel with a plurality of electronic devices;
a processor configured
to acquire a plurality of record items through the connection channel, each record item being generated in response to an operation on a respective electronic device through the connection channel;
to generate a record list which comprises the plurality of the record items; and
to process the record list to associate at least two record items from the plurality of record items, in order to cause respective operations of the electronic devices, to which said at least two record items correspond, to be performed.

8. The electronic device according to claim 7, wherein the processor is further configured:
to acquire from one of the plurality of electronic devices parameter information to generate the corresponding record item in response to the operation;
to judge whether the parameter information matches with an association rule with respect to another record item that corresponds to another electronic device of the plurality of electronic devices; and
if the parameter information matches with the association rule, to transmit, through the connection channel, a control instruction to that other electronic device, such that that other electronic device performs its operation.

9. The electronic device according to claim 6, wherein the processor is configured such that:
if the parameter information matches with the association rule, including the record item corresponding to that other electronic device in the record list.

10. The electronic device according to claim 6, wherein the processor is further configured
to acquire the operation on the corresponding electronic device through the connection channel; and
to use the operation on the corresponding electronic device as one of a plurality of parameters of the record item in relation to the corresponding electronic device.

11. The electronic device according to claim 7, wherein the processor is further configured to acquire through the connection channel user information of a user corresponding to the operation on the corresponding electronic device; and
to use the user information of the user as another of the plurality of parameters of the record item in relation to the corresponding electronic device.

12. The electronic device according to claim 7, wherein the processor is configured to process the record list based on one or more predetermined rules requiring:
an interval among N record items in the record list to be less than an interval threshold; or
the number of occurrences of N record items in the record list to be greater than a number threshold;
or both.
